(19) United States
(12) Patent Application Publication
(10) Pub. No.: US 2021/0256383 A1
(43) Pub. Date: Aug. 19, 2021

(54) COMPUTER-IMPLEMENTED METHODS AND SYSTEMS FOR PRIVACY-PRESERVING DEEP NEURAL NETWORK MODEL COMPRESSION

(71) Applicant: Northeastern University, Boston, MA (US)

(72) Inventors: Yanzhi Wang, Newton Highlands, MA (US); Yifan Gong, Boston, MA (US); Zheng Zhan, Boston, MA (US)

(21) Appl. No.: 17/176,340

(22) Filed: Feb. 16, 2021

Related U.S. Application Data
(60) Provisional application No. 62/976,053, filed on Feb. 13, 2020.

(51) Int. Cl. G06N 3/08; G06N 3/04

(52) U.S. Cl. CPC G06N 3/082; G06N 3/04

(57) ABSTRACT

A privacy-preserving DNN model compression framework allows a system designer to implement a pruning scheme on a pre-trained model without the access to the client's confidential dataset. Weight pruning of the DNN model is formulated without the original dataset as two sets of optimization problems with respect to pruning the whole model or each layer are solved successfully with an ADMM optimization framework. The system allows data privacy to be preserved and real-time inference to be achieved while maintaining accuracy on large-scale DNNs.

### CROSS REFERENCE TO RELATED APPLICATION

This application claims priority from U.S. Provisional Patent Application No. 62/976,053 filed on Feb. 13, 2020 entitled PRIVACY-PRESERVING DNN WEIGHT PRUNING AND MOBILE ACCELERATION FRAMEWORK, which is hereby incorporated by reference.

### GOVERNMENT SUPPORT

This invention was made with government support under Grant No. 1739748 awarded by the National Science Foundation. The government has certain rights in the invention.

### BACKGROUND

The present application relates to methods and systems for performing weight pruning on a Deep Neural Network (DNN) model while maintaining privacy of a training dataset.

The accelerating growth of the number of parameters and operations in modern Deep Neural Networks (DNNs) [9,16,27] has impeded the deployment of DNN models on resource-constrained computing systems. Therefore, various DNN model compression methods, including weight pruning [11,20,21,24,30,34,36,38], low-rank factorization [28,32], transferred/compact convolutional filters [7,33], and knowledge distillation [5,13,18,25,29], have been proposed. Among these, weight pruning enjoys the great flexibility of various pruning schemes and has achieved very good compression rate and accuracy. This application relates primarily to weight pruning.

However, previous model compression methods mainly focus on reducing the model size and/or improving hardware performance (e.g., inference speed and energy efficiency), without considering data privacy requirements. For example, in medical applications, the training data may be patients' medical records [14,15], and in commercial applications, the training data should be kept as confidential to a business. Various embodiments disclosed herein relate to privacy-preserving model compression.

Only few attempts have been made to achieve model compression while pre-serving data privacy by knowledge distillation. Wang et al. propose RONA, where the student model is learned from feature representations of the teacher model on public data [29]. However, RONA still relies on the public data, which is part of the entire dataset. To mitigate the non-availability of the entire training dataset, later works [5,25] depend on complicated synthetic data generation methods to fill the vacancy. Chen et al. exploit generative adversarial networks (GANs) to derive training samples that can obtain the maximum response on the teacher model [5]. Nayak et al. synthesize data impressions from the complex teacher model by modeling the output space of the teacher model as a Dirichlet distribution [25]. Nevertheless, even with carefully designed synthetic data, the accuracy of the student models obtained by these knowledge distillation methods is unsatisfactory. To alleviate the deficiencies of previous work, disclosed herein in accordance with one or more embodiments is PRIV, a privacy-preserving model compression framework that can use randomly generated synthetic data to discover the pruned model architecture with the potential to maintain the accuracy of the pre-trained model. The contributions of our work are summarized as follows:

We develop a PRIVacy-preserving model compression (PRIV) framework that formulates a privacy-preserving DNN weight pruning problem and develops an ADMM (alternating direction method of multipliers) based solution to support different types of weight pruning schemes including irregular pruning, filter pruning, column pruning, and pattern-based pruning.

In the PRIV framework, the system designer performs the privacy-preserving weight pruning process on a pre-trained model without the confidential training dataset from the client. The goal of the system designer is to discover a pruned model architecture that has the potential for maintaining the accuracy of the pre-trained model. The client's effort is then simply reduced to performing the retraining process using her confidential training dataset for boosting the accuracy of the pruned model. The retraining process is similar as the DNN training process with the help of the mask function from the system designer.

The PRIV framework is motivated by knowledge distillation. But we only use randomly generated synthetic data, while the existing privacy-preserving knowledge distillation works employ complicated synthetic data generation methods. Our framework is different from knowledge distillation, which specifies the student model architecture beforehand, while our privacy-preserving weight pruning process discovers the pruned model architecture gradually through the optimization process.

Experimental results demonstrate that our framework can implement DNN weight pruning while preserving the training data privacy. For example, using VGG-16 and ResNet-18 on CIFAR-10 with the irregular pruning scheme, our PRIV framework can achieve the same model compression rate with negligible accuracy loss compared to the traditional weight pruning process (no data privacy requirement). Prototyping on a mobile phone device shows that we achieve significant speedups in the end-to-end inference time compared with other state-of-the-art works. For example, we achieve 25 ms end-to-end inference time with ResNet-18 on ImageNet using Samsung Galaxy S10, without accuracy loss, corresponding to 4.2×, 2.3×, and 2.1× speedups comparing with TensorFlow-Lite, TVM, and MNN, respectively.

Related Work of DNN Weight Pruning

We illustrate different weight pruning schemes in FIGS. 1A-1D, where the grey blocks represent the pruned weights. FIG. 1A shows the irregular pruning scheme [8,21,26,34], which is a non-structured pruning scheme. Irregular pruning prunes weights at arbitrary locations. It can achieve very high compression rate, but the resultant irregular weight sparsity is not compatible with data parallel executions on the computing systems. By imposing certain regularities on the pruned models, structured pruning schemes [11,12,17,20,23,30,31,36,37,38] maintain the full matrix format with reduced dimensions, thus facilitating implementations on the resource-constrained computing systems.

Structured pruning can be further categorized into filter pruning [12,22] as in FIG. 1B), column pruning [19,35] as in FIG. 1C, and pattern-based pruning [23,31] as in FIG. 1D. Filter pruning by the name prunes whole filters from a layer. Some references mention channel pruning [12], which as implied by the name, prunes some channels completely from the filters. Essentially channel pruning is equivalent to filter pruning because if some filters are pruned in a layer, it makes the corresponding channels of next layer invalid. Column pruning (filter shape pruning) prunes weights for all filters in a layer, at the same locations. Pattern-based pruning is a combination of the kernel pattern pruning scheme and the connectivity pruning scheme. In kernel pattern pruning, for each kernel in a filter, a fixed number of weights are pruned, and the remaining weights form specific kernel patterns. The example in FIG. 1D is defined as 4-entry kernel pattern pruning, since every kernel reserves 4 non-zero weights out of the original 3×3 kernel. The connectivity pruning cuts the connections between some input and output channels, which is equivalent to removing corresponding kernels.

### BRIEF SUMMARY OF THE DISCLOSURE

A method in accordance with one or more embodiments is disclosed for performing weight pruning on a Deep Neural Network (DNN) model while maintaining privacy of a training dataset controlled by another party. The method includes the steps of (a) receiving a pre-trained DNN model; (b) performing a weight pruning process on the pre-trained DNN model using randomly generated synthetic data instead of the training dataset to generate a pruned DNN model and a mask function; and (c) providing the mask function and the pruned DNN model said another party such that said another party can retrain the pruned DNN model with the training data set using the mask function.

A computer system in accordance with one or more embodiments includes at least one processor, memory associated with the at least one processor, and a program supported in the memory for performing weight pruning on a Deep Neural Network (DNN) model while maintaining privacy of a training dataset controlled by another party. The program contains a plurality of instructions which, when executed by the at least one processor, cause the at least one processor to: (a) receive a pre-trained DNN model; (b) perform a weight pruning process on the pre-trained DNN model using randomly generated synthetic data instead of the training dataset to generate a pruned DNN model and a mask function; and (c) provide the mask function and the pruned DNN model said another party such that said another party can retrain the pruned DNN model with the training data set using the mask function.

### BRIEF DESCRIPTION OF THE DRAWINGS

FIGS. 1A-1D are simplified diagrams illustrating various different weight pruning schemes.

FIG. 2A is a simplified diagram illustrating a conventional DNN weight pruning process. FIG. 2B illustrates a training dataset privacy preserving DNN weight pruning process in accordance with one or more embodiments.

FIGS. 3A-3B are graphs illustrating mobile CPU/GPU inference time of the pruned model on different platforms in accordance with one or more embodiments.

FIG. 4 shows an exemplary privacy-preserving weight pruning algorithm in accordance with one or more embodiments.

FIGS. 5-8 show Tables 1-4, respectively.

FIG. 9 is a block diagram illustrating an exemplary computer system in which the methods described herein in accordance with one or more embodiments can be implemented.

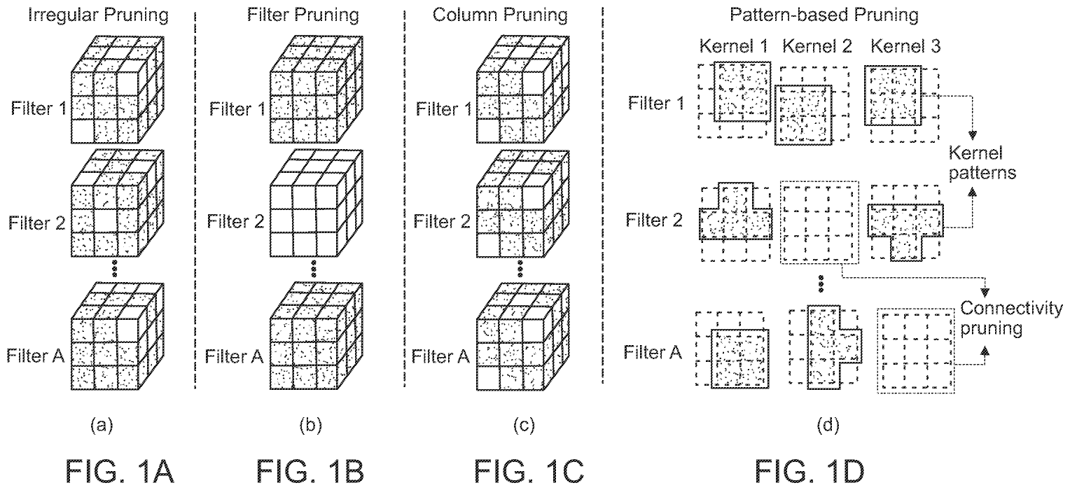

### DETAILED DESCRIPTION

### Overview of the PRIV Framework

Traditional DNN Weight Pruning Process

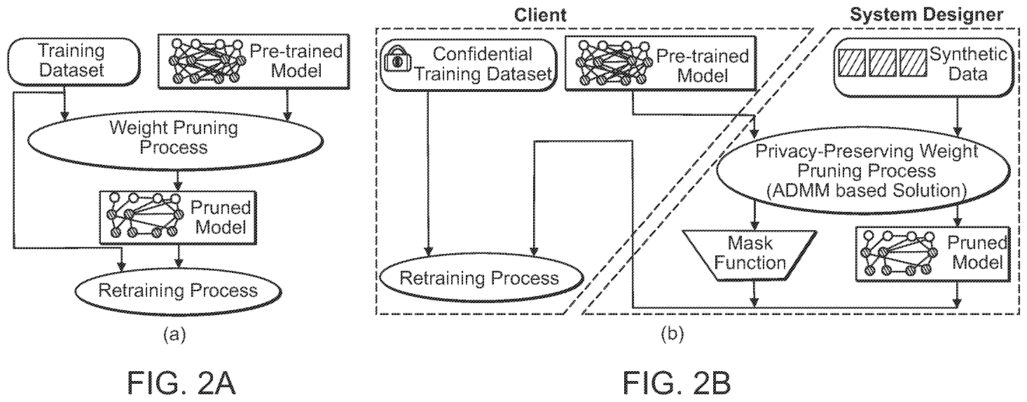

In this section we introduce the traditional DNN weight pruning process, where there is no data privacy requirement, i.e., the training dataset is available for the whole DNN weight pruning process. FIG. 2A describes the traditional DNN weight pruning process, which starts with a pre-trained model and the training dataset. Then the weight pruning process implements a particular weight pruning scheme to obtain a pruned model. The weight pruning process leads to inefficacy of the model accuracy. Therefore, a retraining process is needed to enhance the accuracy of the pruned model with the training dataset [10,11,17,30,37].

The PRIV Framework

This section provides the overview of the PRIV framework in accordance with one or more embodiments where a system designer will implement a DNN weight pruning scheme on a pre-trained model provided by a client to facilitate the deployment of DNN inference model on a hardware computing system. (In the experiment section, we will demonstrate results from deployments of pruned DNN models on a mobile phone device.) However, the client holds the confidential training dataset that she could not share with the system designer due to data privacy requirements. For example, in medical applications the training data may be patients' medical records [14,15] and in commercial applications the training data should be kept confidential for business reasons.

We make the following observations from the traditional DNN weight pruning process, which motivates our PRIV framework to mitigate the non-availability of the training dataset to the system designer. (i) The weight pruning process is for discovering a pruned model architecture that has the potential for maintaining the accuracy of the pre-trained model. (ii) The retraining process is the key to boost the accuracy of the pruned model, and the training dataset must be used for it. (iii) The retraining process is similar to the DNN training process except that it needs a mechanism to ensure the pruned weights are zeros and not updated during back propagation.

FIG. 2B illustrates the workflow of an exemplary PRIV framework in accordance with one or more embodiments. The client has the confidential training dataset and a pre-trained model. The system designer performs the privacy-preserving weight pruning process on the pre-trained model from the client with the randomly generated synthetic data. The generation of the synthetic data does not rely on any prior knowledge about the client's confidential training dataset. In the experiments, we simply set the value of each pixel of the synthetic images with a discrete uniform distribution in the range of 0 to 255. We formulate a privacy-preserving weight pruning problem and develop an ADMM (alternating direction method of multipliers) based solution to support different types of weight pruning schemes. We have tested on the irregular pruning, filter pruning, column pruning, and pattern-based pruning schemes in the experiments. The outputs of the privacy-preserving weight pruning process consist of a pruned model and a mask function. Then the client performs the retraining process with her confidential training dataset and the mask function on the pruned model.

In the above-described PRIV framework, the system designer takes charge of the major privacy-preserving weight pruning process, whereas the client's effort is simply reduced to the retraining process, which is similar as the DNN training process with the help of the mask function from the system designer. According to the observation (i), we found that the randomly generated synthetic data can serve for the purpose of learning a pruned model architecture, given our privacy-preserving weight pruning problem formulation. Based on the observation (ii), only the client herself can perform the retraining process with her confidential training dataset to boost the accuracy of the pruned model. And according to the observation (iii), the mask function from the system designer helps to simplify the retraining process of the client, who does not need to learn the sophisticated DNN weight pruning techniques.

Privacy-Preserving Weight Pruning Process

This section presents the privacy-preserving weight pruning process. We begin with the notations. Then two problem formulations are presented: one refers to the whole model inference results of the pre-trained model and the other one refers to the layer-wise inference results of the pre-trained model. Next, we provide the ADMM based solution, followed by the supports of different weight pruning schemes.

DNN Model Notations

Unless otherwise specified, we use the following notations throughout the paper. We mainly focus on the pruning of the computation-intensive convolutional (CONV) layers. For an N-layer DNN, let An, Bn, Cn, Dn denote the number of filters, the number of channels, the height of filter kernel, and the width of filter kernel of the n-th CONV layer, respectively. Therefore, the weight tensor of the n-th CONV layer is represented as

[symbol]

ϵ [symbol] Aₙ×Bₙ×Cₙ×Dₙ.

Then the corresponding GEMM matrix representation of Wn is given as

Wₙϵ [symbol] Pₙ×Qₙ,

with Pn=An and Qn=Bn·Cn·Dn. We use

bₙϵ [symbol] ^{P}^{ₙ}

to denote the bias for the n-th layer. We also define

W:={Wₙ}ₙ₌₁^{N} and b:={bₙ}ₙ₌₁^{N}

as the sets of all weight matrices and biases of the neural network.

We use X for the input to a DNN. It may represent a randomly generated synthetic data or a data point from the confidential training dataset. Let σ(⋅) denote the element-wise activation function. The output of the n-th layer with respect to the input X is given by

[symbol]

_{:n}(X):=(fₙ∘fₙ₋₁∘ . . . ∘fᵢ∘ . . . ∘f₁)(X), (1)

where fi(⋅) represents the operation in layer i, and is defined as fi(x)=σ(Wix+bi) for i=1, . . . , n. Furthermore, to distinguish the pre-trained model from others, we use the apostrophe symbol W′n, b′n, F′:n, f′n for the pre-trained model from the client in the same way as mentioned above.

Problem Formulation

The difficulty of the privacy-preserving weight pruning process is the non-availability of the training dataset, without which it is difficult to ensure that the pruned model has the potential for maintaining the accuracy of the pre-trained model. To mitigate this problem, we use randomly generated synthetic data X without any prior knowledge of the confidential training dataset. Then motivated by knowledge distillation [13], we hope to distill the knowledge of the pre-trained model into the pruned model by minimizing the difference between the outputs of the pre-trained model (teacher model) and the outputs of the pruned model (student model), given the same synthetic data as the inputs. Different from the traditional knowledge distillation, which specifies the student model architecture beforehand, our privacy-preserving weight pruning process (i) uses randomly generated synthetic data instead of the training dataset, and (ii) initializes the student model (pruned model) the same as the teacher model (pre-trained model) and then discovers the student model architecture gradually through the weight pruning process.

Therefore, we formulate the privacy-preserving weight pruning problem with:

$${minimize}_{W , b} {‖ {ℱ}_{: N} ( X ) - {ℱ}_{: N}^{′} ( X ) ‖}_{F}^{2} , subject to \\ {W}_{n} ∈ {S}_{n} , n = 1 , … , N . \qquad ( 2 )$$

The objective function is the difference (measured by Frobenius norm) between the outputs of the pre-trained model)

[symbol] _{:N}(X) and those of the pruned model

[symbol] _{:N}(X),

given the same synthetic data X. Note that we use the soft inference results (i.e., scores or probabilities of a data point belonging to different classes) instead of the hard inference results (i.e., the final class label of a data point) to distill the knowledge from the pre-trained model more precisely. And in the above problem formulation, we use Sn to denote the weight sparsity constraint set for the n-th layer. Namely, different weight pruning schemes can be defined through the set Sn. Further discussion about Sn is provided below.

However, problem (2) uses the whole model inference results. In the case of very deep models, it may have the exploding and vanishing gradient problems. Inspired by the layer-wise knowledge distillation [18], we improve the problem (2) formulation using a layer-wise approach, i.e., the layer-wise inference results:

$${minimize}_{{W}_{n} , {b}_{n}} {‖ σ ( {W}_{n} {ℱ}_{: n - 1} ( X ) + {b}_{n} ) - {ℱ}_{: n}^{′} ( X ) ‖}_{F}^{2} , subject to {W}_{n} ∈ {S}_{n} . \qquad ( 3 )$$

To perform weight pruning on the whole model, problem (3) is solved for layer n=1 to n=N. The effectiveness of problem (3) compared with problem (2) is presented in Section 5.4. The formulations of problems (2) and (3) are analogous to the whole model and layer-wise knowledge distillation, respectively.

ADMM Based Solution

The above-mentioned optimization problems (2) and (3) are both in general difficult to solve due to the nonconvex constraints. To tackle this, we consider to utilize the ADMM optimization framework to decompose the original problem into simpler sub-problems. We provide the detailed solution to problem (3) in this section. A similar solution can be obtained for problem (2) too. We begin by re-writing problem (3) as

$${minimize}_{{W}_{n} , {b}_{n}} {‖ σ ( {W}_{n} {ℱ}_{: n - 1} ( X ) + {b}_{n} ) - {ℱ}_{: n}^{′} ( X ) ‖}_{F}^{2} + ℐ ( {Z}_{n} ) , \\ subject to {W}_{n} = {Z}_{n} . \qquad ( 4 )$$

where Zn is the auxiliary variable, and I(⋅) is the indicator function of Sn, i.e.,

$$ℐ ( {W}_{n} ) = \{ \begin{matrix}0 & if {W}_{n} ∈ {S}_{n} , \\ + ∞ & otherwise\end{matrix} \qquad ( 5 )$$

The augmented Lagrangian [4] of the optimization problem (4) is given by

$$ℒ ( {W}_{n} , {b}_{n} , {Z}_{n} , {U}_{n} ) = {‖ σ ( {W}_{n} {ℱ}_{: n - 1} ( X ) + {b}_{n} ) - {ℱ}_{: n}^{′} ( X ) ‖}_{F}^{2} + ℐ ( {Z}_{n} ) + \frac{ρ}{2} {‖ {W}_{n} - {Z}_{n} + {U}_{n} ‖}_{F}^{2} + \frac{ρ}{2} {‖ {U}_{n} ‖}_{F}^{2} , \qquad ( 6 )$$

where Un is the dual variable and p represents the augmented penalty. The ADMM algorithm proceeds by repeating the following iterative optimization process until convergence. At the k-th iteration, the steps are given by

$$\begin{matrix}{W}_{n}^{k} , {b}_{n}^{k} := {argmin}_{{W}_{n} , {b}_{n}} ℒ ( {W}_{n} , {b}_{n} , {Z}_{n}^{k - 1} , {U}_{n}^{k - 1} ) & ( Primal ) \\ {Z}_{n}^{k} := {argmin}_{{Z}_{n}} ℒ ( {W}_{n}^{k} , {b}_{n}^{k} , {Z}_{n} , {U}_{n}^{k - 1} ) & ( Proximal ) \\ {U}_{n}^{k} := {U}_{n}^{k - 1} + {W}_{n}^{k} - {Z}_{n}^{k} . & ( 7 )\end{matrix}$$

The ADMM steps are equivalent to the following Proposition 1.

Proposition 1 The ADMM subproblems (Primal) and (Proximal) can be equivalently transformed into a) Primal-minimization step and b) Proximal-minimization step. More specifically:

Primal-minimization step: The solution Wₙ^{k}, bₙ^{k} can be obtained by solving the following simplified problem (Primal):

$${minimize}_{{W}_{n} , {b}_{n}} {‖ σ ( {W}_{n} {ℱ}_{: n - 1} ( X ) + {b}_{n} ) - {ℱ}_{: n}^{′} ( X ) ‖}_{F}^{2} + \frac{ρ}{2} {‖ {W}_{n} - {Z}_{n}^{k - 1} + {U}_{n}^{k - 1} ‖}_{F}^{2} . \qquad ( 8 )$$

The first term in Eqn. (8) is the differential reconstruction error while the second term is quadratic and differentiable. Thus, this subproblem could be solved by stochastic gradient descent (SGD) effectively.

Proximal-minimization step: After obtaining the solution Wₙ^{k} of the primal problem at iteration k, Zₙ^{k} can be obtained by solving the problem (Proximal):

$${minimize }_{{Z}_{n}} ℐ ( {Z}_{n} ) + \frac{ρ}{2} {‖ {W}_{n}^{k} - {Z}_{n} + {U}_{n} ‖}_{F}^{2} . \qquad ( 9 )$$

As I(⋅) is the indicator function of the constraint set Sn, the globally optimal solution of problem (proximal) can be derived as

$${Z}_{n}^{k} = {\prod }_{{S}_{n}} ( {W}_{n}^{k} + {U}_{n}^{k - 1} ) , \qquad ( 10 )$$

where Π_{Sn}(⋅) is the Euclidean projection onto the constraint set Sn. 4.4 Definitions of Sn for Different Weight Pruning Schemes

This subsection introduces how to leverage the weight sparsity constraint WnϵSn to implement various weight pruning schemes. For each weight pruning scheme, we introduce the exact form of Sn, and provide the explicit solution to problem (Proximal). To help express the constraints, we first define an indicator function for any matrix Y by

$$g ( Y ) = \{ \begin{matrix}0 & if ∀ element y ∈ Y , y = 0 , \\ 1 & otherwise\end{matrix} . \qquad ( 11 )$$

Furthermore, we denote a as the desired remaining weight ratio, defined as the number of remaining weights in the pruned model divided by the total number of weights in the pre-trained model.

Irregular pruning In irregular pruning, the constraint set is represented as Eqn. (12). The solution to problem (Proximal) is to keep the elements with the [bαPnQn] largest magnitudes and set the rest to zeros.

$${W}_{n} ∈ {S}_{n} := \{ {W}_{n} \vert ( \frac{1}{{P}_{n} {Q}_{n}} {\sum }_{p = 1}^{{P}_{n}} {\sum }_{q = 1}^{{Q}_{n}} g ( {[ {W}_{n} ]}_{p , q} ) ) \leq α \} . \qquad ( 12 )$$

Filter pruning Filter pruning prunes the rows of the GEMM weight matrix, as represented in Eqn. (13). To obtain the solution to problem (Proximal), we first calculate

Ôₚ=∥[Wₙ^{k}+Uₙ^{k-1}]ₚ,:∥_{F}², for p=1, . . . ,Pₙ.

We then keep [αPn] rows in [Wₙ^{k}+Uₙ^{k-1}], corresponding to the [αPn] largest values in {\hat{ }Op}^{Pn}ₚ₋₁, and set the rest to zeros.

$${W}_{n} ∈ {S}_{n} := \{ {W}_{n} \vert ( \frac{1}{{P}_{n}} {\sum }_{p = 1}^{{P}_{n}} g ( {[ {W}_{n} ]}_{p , :} ) ) \leq α \} . \qquad ( 13 )$$

Column pruning Column pruning restricts the number of columns in the GEMM weight matrix that contain non-zero weights, as expressed in Eqn. (14). The solution to problem (Proximal) can be obtained by first calculating

O_{q}=∥[Wₙ^{k}+Uₙ^{k-1}]_{:,q}∥_{F}², for q=1, . . . ,Qₙ,

then keeping [αQn] columns in [Wₙ^{k}+Uₙ^{k-1}] with the [αQn] largest values in {Oq}^{Qn}_{q=1}, and setting the rest to zeros.

$${W}_{n} ∈ {S}_{n} := \{ {W}_{n} \vert ( \frac{1}{{Q}_{n}} {\sum }_{q = 1}^{{Q}_{n}} g ( [ {W}_{n} ] : , q ) ) \leq α \} . \qquad ( 14 )$$

Pattern-based pruning For pattern-based pruning, we focus on 3×3 kernels, i.e., Cn=Dn=3, since they are widely adopted in various DNN architectures [9,27]. Pattern-based pruning is composed of kernel pattern pruning and connectivity pruning. Kernel pattern pruning removes weights at intra-kernel level. Each pattern shape reserves four non-zero values in a kernel to match the SIMD (single-instruction multiple-data) architecture of embedded CPU/GPU processors, thereby maximizing hardware throughput. Connectivity pruning removes whole kernels and achieves inter-kernel level pruning, which is a good supplement to kernel pattern pruning for higher compression and acceleration rate. Pattern-based pruning can be achieved by solving the kernel pattern pruning problem and connectivity pruning problem sequentially. For kernel pattern pruning, the constraint set can be represented as

$${W}_{n} ∈ {S}_{n} := \{ {W}_{n} \vert ( {\sum }_{c = 1}^{{C}_{n}} {\sum }_{d = 1}^{{D}_{n}} g ( {[ {W}_{n} ]}_{a , b , c , d} ) ) = 4 , ∀ 1 \leq a \leq {A}_{n} , \\ ∀ 1 \leq b \leq {B}_{n} \} . \qquad ( 15 )$$

Wn is the GEMM matrix representation of Wn. The solution to problem (Proximal) can be obtained by reserving four elements with the largest magnitudes in each kernel. After kernel pattern pruning, we can already achieve a 2.25× compression rate. For further parameter reduction, connectivity pruning is adopted, and the constraint set is defined as

$${W}_{n} ∈ {S}_{n} := \{ {W}_{n} \vert ( \frac{1}{{A}_{n} {B}_{n}} {\sum }_{a = 1}^{{A}_{n}} {\sum }_{b = 1}^{{B}_{n}} g ( {[ {W}_{n} ]}_{a , b , : , :} ) ) \leq 2.25 α \} . \qquad ( 16 )$$

The solution to problem (Proximal) is to reserve [2.25αAnBn] kernels with the largest Frobenius norm.

Overall Algorithm

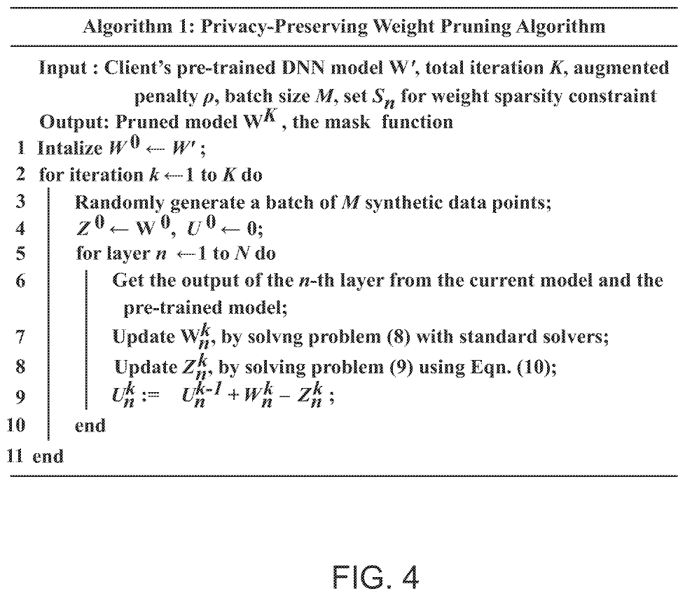

The solution of the privacy-preserving weight pruning problem is summarized in Algorithm 1 (FIG. 4). The system designer starts pruning with the pre-trained model W′ from the client. At the beginning of each iteration k, a batch of M synthetic data points are generated and used as the training data to prune redundant weights. The pruning is performed layer-by-layer for the whole model. Finally, the pruned model W^{K} and mask function are released to the client for retraining.

Experimental Results

In this section, we evaluate the PRIV performance by comparing with state-of-the-art methods. It includes the following aspects: 1) demonstrate the compression rate and accuracy performance of the pruned model by PRIV, and compare it with traditional weight pruning methods to show that PRIV can achieve high model compression rate while preserving client's data privacy; 2) present the inference speedup of the compressed model on mobile devices; 3) show the effectiveness of per-layer pruning method by solving problem (3) compared with pruning the whole model directly by solving problem (2) in terms of maintaining the accuracy.

Experiment Setup

In order to evaluate whether PRIV can consistently attain efficient pruned models for tasks with different complexities, we test on three representative network structures, i.e., VGG-16, ResNet-18, and ResNet-50, with three major image classification datasets, i.e., CIFAR-10, CIFAR-100, and ImageNet. Here, CIFAR-10, CIFAR-100, and ImageNet are viewed as the client's confidential datasets. All these pruning processes of the system designer are carried out on GeForce RTX 2080Ti GPUs.

During pruning, we adopt the following parameter settings. We initialize the penalty value ρ=1×10-4, and increase p by 10 times for every 11 epochs, until p reaches 1×10-1. SGD optimizer is utilized for the optimization steps with a learning rate of 1×10-3. An epoch corresponds to 10 iterations, and each iteration process a batch of data. The batch size M is set to 32. Each input sample is generated by setting the value of each pixel with a discrete uniform distribution in the range of 0 to 255. To demonstrate the effectiveness of the privacy-preserving pruning, we also implement the traditional ADMM based pruning algorithm (ADMM†) [34] which requires the original dataset. For the ADMM†, we use the same penalty value and learning rate to achieve a fair comparison. Besides, for each p value, we train 100 epochs for CIFAR-10 and CIFAR-100 with a batch size of 64, and 25 epochs for ImageNet with a batch size of 256 due to the complexity of the original datasets.

To show the acceleration performance of the pruned model on mobile devices, we measure the inference speedup on our compiler-assisted mobile acceleration framework and compare it with three state-of-the-art DNN inference acceleration frameworks, i.e., TFLite [1], TVM [6], and MNN [2]. The measurements are conducted on a Samsung Galaxy S10 cell phone with the latest Qualcomm Snapdragon 855 mobile platform consisting of a Qualcomm Kryo 485 Octacore CPU and a Qualcomm Adreno 640 GPU.

Accuracy and Compression Rate Evaluations

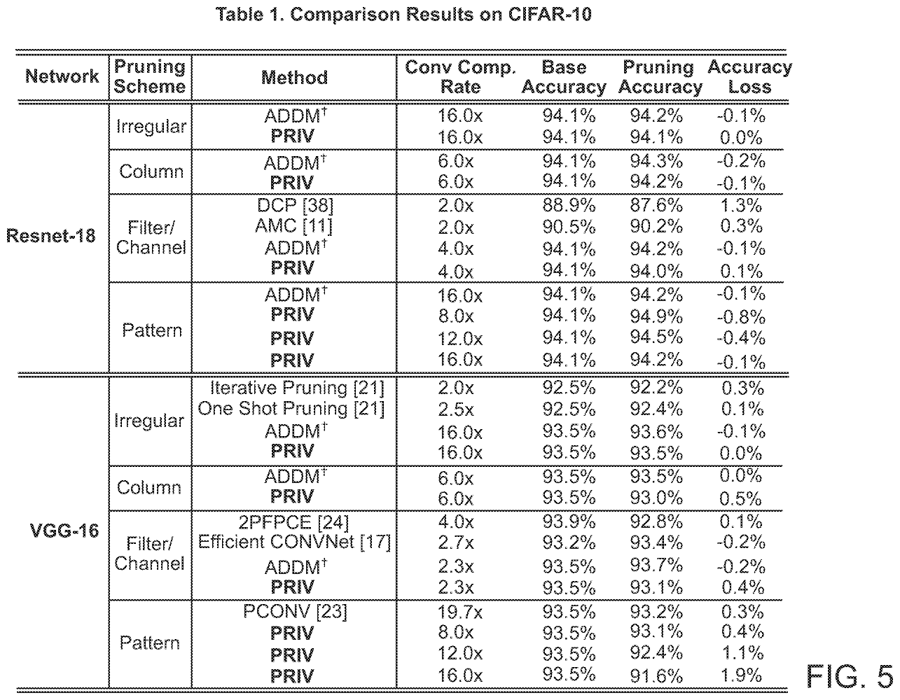

Evaluation on CIFAR-10 Dataset: We first experiment on CIFAR-10 dataset with VGG-16 and ResNet-18. The results are shown in Table 1 (FIG. 5), where base accuracy represents the accuracy of the pre-trained model, and pruning accuracy refers to the accuracy of the pruned model after retraining. Our PRIV achieves a 16× compression rate with up to 94.2% pruning accuracy for ResNet-18, and a 16× compression rate with up to 91.6% pruning accuracy for VGG-16. Compared with other baseline methods not based on ADMM, PRIV can achieve a higher compression rate and pruning accuracy in most cases. Compared with other ADMM-based methods, such as ADMM† or PCONV [23], PRIV can achieve a very similar compression rate and pruning accuracy without any access to the original dataset, thus preserving data privacy.

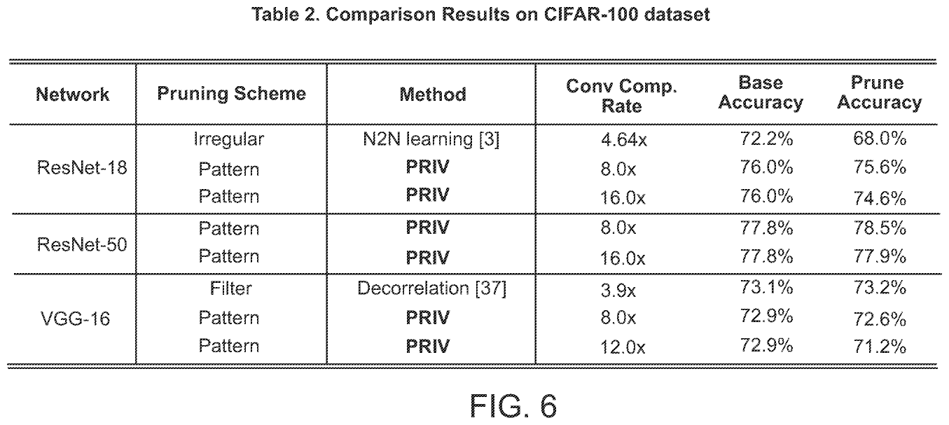

Evaluation on CIFAR-100 Dataset: With satisfying compression performance and compatibility with hardware implementations, we use pattern pruning scheme to further demonstrate the PRIV performance on CIFAR-100 dataset, as shown in Table 2 (FIG. 6). PRIV can obtain a 16× compression rate on ResNet-18 and ResNet-50, and a 12× compression rate on VGG-16, while the top-1 accuracy loss is −0.1%˜1.7%. The baseline methods usually have much lower compression rates (around 4×). We highlight that PRIV not only achieves higher compression rates but also does not rely on any access to the original dataset.

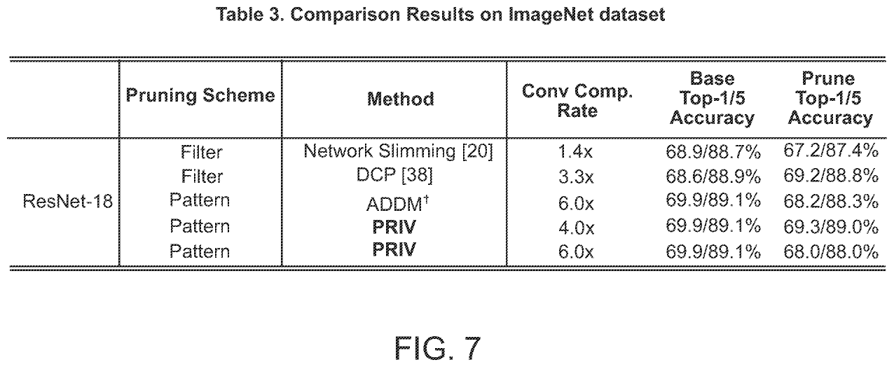

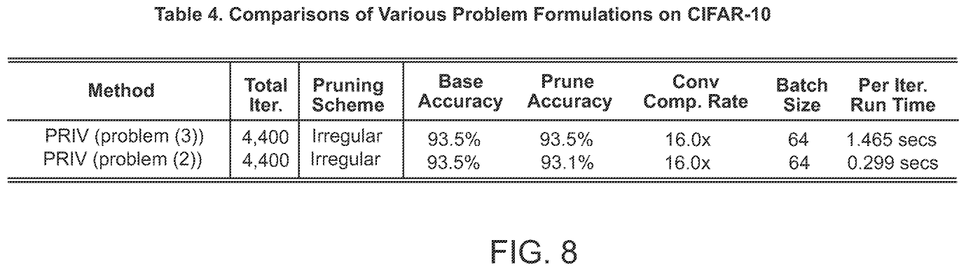

Evaluation on ImageNet Dataset With promising results on CIFAR-10 and CIFAR-100, we further investigate the PRIV performance on ImageNet with ResNet-18. As demonstrated in Table 3 (FIG. 7), we achieve a 4× compression rate with 69.3%/89.0% top-1/top-5 accuracy, which are both higher than the Network Slimming [20] and DCP [38]. We could further reach a 6× compression rate with 88.0% top-5 accuracy. Combining all of the results on the three different datasets, we can conclude that PRIV is able to achieve satisfying compression, accuracy, and privacy performance for tasks with different complexities.

Performance Evaluation on Mobile Platform

In this section, we demonstrate the evaluation results on a mobile device to show the real-time inference of the pruned model provided by PRIV with the help of our compiler-assisted acceleration framework. To guarantee fairness, the same pattern-based sparse models are used for TFLite [1], TVM [6] and MNN [2], and fully optimized configurations of all frameworks are enabled.

For pattern-based models, our compiler-assisted acceleration framework has three pattern-enabled compiler optimizations for each DNN layer: filter kernel reorder, compressed weight storage, and load redundancy elimination. These optimizations are conducted on a layer-wise weight representation incorporating information of layer shape, pattern style, connectivity status, etc. These general optimizations can work for both CPU and GPU code generations.

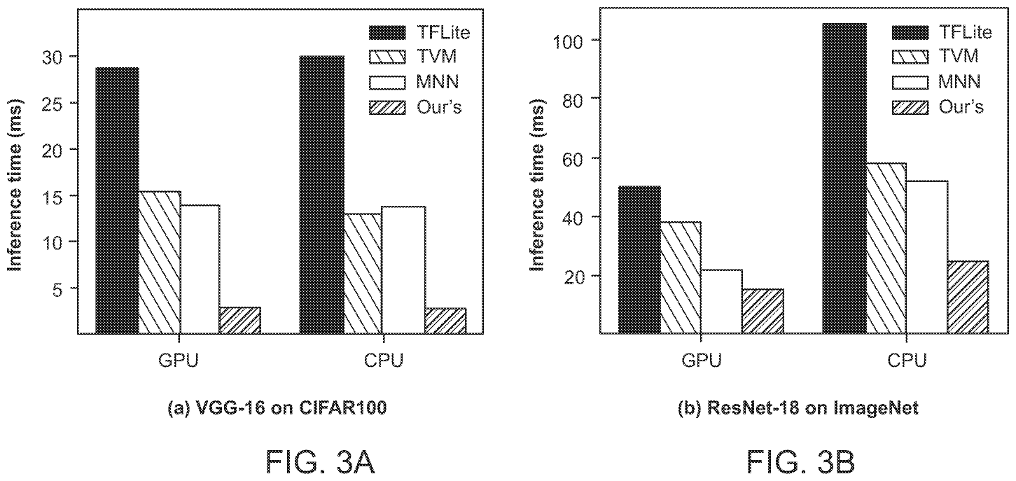

FIGS. 3A-3B show the mobile CPU/GPU inference time of the model on different platforms. We use two models obtained by PRIV, i.e., VGG-16 on CIFAR-100 dataset with a 12× compression rate (in Table 2) and ResNet-18 on ImageNet with a 6× compression rate (in Table 3), as the testing models. Real-time execution typically requires 30 frames/sec, i.e., 33 ms/frame. As observed from FIGS. 3A-3B, our approach achieves significant acceleration on mobile devices, satisfying the real-time inference requirement. Compared with other frameworks, our compiler-assisted mobile acceleration framework achieves 4.2× to 10.8× speedup over TFLite, 2.3× to 4.6× speedup over TVM and 2.1× to 4.9× speedup over MNN on CPU. On GPU, we achieve 3.3× to 10.1× speedup over TFLite, 2.5× to 5.4× speedup over TVM and 1.4× to 4.9× speedup over MNN. The significant acceleration performance is attributed to specific optimizations for sparse models with compiler's assistance.

Evaluations of Different Problem Formulations

We compare the performance of solving problem (3) with that of solving problem (2). For a fair comparison, we adopt the same batch size of 64 and use the same irregular pruning of VGG-16 on the CIFAR-10 dataset with a 16× compression rate. As shown in Table 4, with the per-layer pruning formulation (3), PRIV maintains the accuracy (0% accuracy loss) without the knowledge of the original dataset. By contrast, optimizing over the entire model directly with formulation (2) degrades the accuracy by 0.4%. From our empirical studies, even if we increase the number of iterations for the pruning with formulation (2), the accuracy of the pruned model cannot increase. We attribute the difference in the accuracy performance of these two formulations to the additional usage of the inference results of each intermediate layer in the model in problem (3). In terms of run time, solving problem (3) has a longer per iteration run time, which is 4.9× to solving problem (2). This is because, in each iteration, pruning a model with N CONV layers requires solving problem (3) N times. For VGG-16, N=12. The per iteration run time of problem (3) is not as high as 12× to that of problem (2) since solving problem (2) requires optimizing over the entire set of model weights.

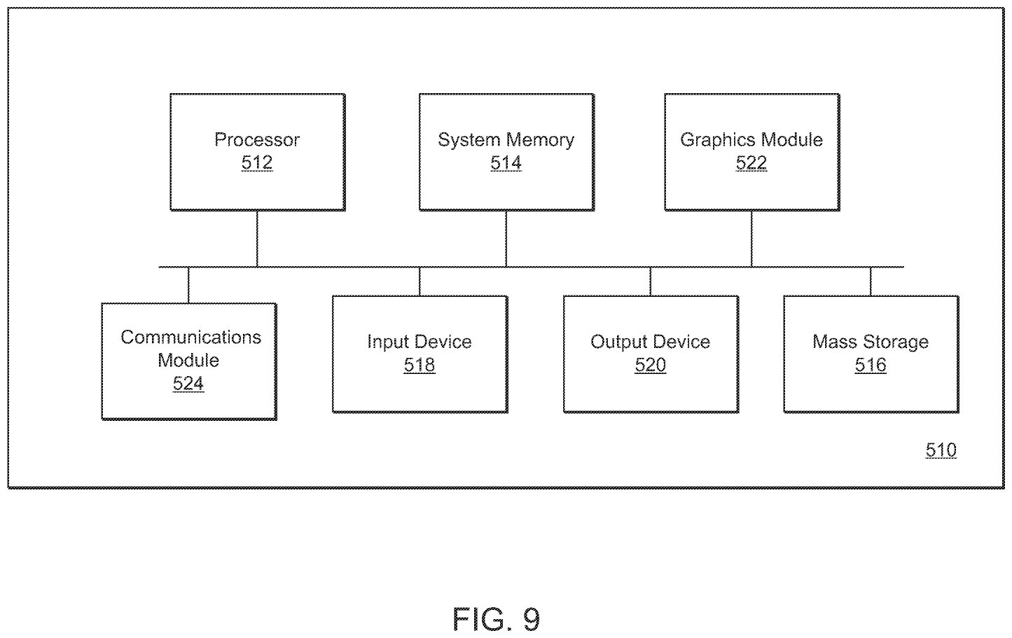

The methods, operations, modules, and systems of the PRIV framework may be implemented in one or more computer programs executing on a programmable computer system. FIG. 9 is a simplified block diagram illustrating an exemplary computer system 510, on which the one or more computer programs may operate as a set of computer instructions. The computer system 510 includes, among other things, at least one computer processor 512, system memory 514 (including a random access memory and a read-only memory) readable by the processor 512. The computer system 510 also includes a mass storage device 516 (e.g., a hard disk drive, a solid-state storage device, an optical disk device, etc.). The computer processor 512 is capable of processing instructions stored in the system memory or mass storage device. The computer system additionally includes input/output devices 518, 520 (e.g., a display, keyboard, pointer device, etc.), a graphics module 522 for generating graphical objects, and a communication module or network interface 524, which manages communication with other devices via telecommunications and other networks.

Each computer program can be a set of instructions or program code in a code module resident in the random access memory of the computer system. Until required by the computer system, the set of instructions may be stored in the mass storage device or on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

### REFERENCES

1. https://www.tensorflow.org/lite/performance/model_optimization
2. https://github.com/alibaba/MNN
3. Ashok, A., Rhinehart, N., Beainy, F., Kitani, K. M.: N2n learning: Network to network compression via policy gradient reinforcement learning. In: Proceedings of International Conference on Learning Representations (ICLR) (2018)
4. Boyd, S., Parikh, N., Chu, E., Peleato, B., Eckstein, J., et al.: Distributed optimization and statistical learning via the alternating direction method of multipliers. Foundations and Trends in Machine learning 3(1), 1-122 (2011)
5. Chen, H., Wang, Y., Xu, C., Yang, Z., Liu, C., Shi, B., Xu, C., Xu, C., Tian, Q.: Data-free learning of student networks. In: Proceedings of the IEEE International Conference on Computer Vision (ICCV). pp. 3514-3522 (2019)
6. Chen, T., Moreau, T., Jiang, Z., Zheng, L., Yan, E., Shen, H., Cowan, M., Wang, L., Hu, Y., Ceze, L., et al.: Tvm: An automated end-to-end optimizing compiler for deep learning. In: the USENIX Symposium on Operating Systems Design and Implementation (OSDI). pp. 578-594 (2018)
7. Dieleman, S., De Fauw, J., Kavukcuoglu, K.: Exploiting cyclic symmetry in con-volutional neural networks. In: Proceedings of the International Conference on International Conference on Machine Learning (ICML). vol. 48, pp. 1889-1898 (2016)
8. Dong, X., Chen, S., Pan, S.: Learning to prune deep neural networks via layer-wise optimal brain surgeon. In: Advances in Neural Information Processing Systems (NeurIPS). pp. 4857-4867 (2017)
9. He, K., Zhang, X., Ren, S., Sun, J.: Deep residual learning for image recognition. In: Proceedings of the IEEE Conference on Computer Vision and Pattern Recognition (CVPR). pp. 770-778 (2016)
10. He, Y., Dong, X., Kang, G., Fu, Y., Yan, C., Yang, Y.: Asymptotic soft filter pruning for deep convolutional neural networks. IEEE Transactions on Cybernetics (2019)
11. He, Y., Lin, J., Liu, Z., Wang, H., Li, L. J., Han, S.: Amc: Automl for model compression and acceleration on mobile devices. In: Proceedings of the European Conference on Computer Vision (ECCV). pp. 784-800 (2018)
12. He, Y., Zhang, X., Sun, J.: Channel pruning for accelerating very deep neural net-works. In: Proceedings of the IEEE International Conference on Computer Vision (ICCV). pp. 1389-1397 (2017)
13. Hinton, G., Vinyals, O., Dean, J.: Distilling the knowledge in a neural network. arXiv preprint arXiv:1503.02531 (2015)
14. Jochems, A., Deist, T. M., El Naqa, I., Kessler, M., Mayo, C., Reeves, J., Jolly, S., Matuszak, M., Ten Haken, R., van Soest, J., et al.: Developing and validating a survival prediction model for nscic patients through distributed learning across 3 countries. International Journal of Radiation Oncology* Biology* Physics 99(2), 344-352 (2017)
15. Jochems, A., Deist, T. M., Van Soest, J., Eble, M., Bulens, P., Coucke, P., Dries, W., Lambin, P., Dekker, A.: Distributed learning: developing a predictive model based on data from multiple hospitals without data leaving the hospital—a real life proof of concept. Radiotherapy and Oncology 121(3), 459-467 (2016)
16. Krizhevsky, A., Sutskever, I., Hinton, G. E.: Imagenet classification with deep con-volutional neural networks. In: Advances in Neural Information Processing Systems (NeurIPS). pp. 1097-1105 (2012)
17. Li, H., Kadav, A., Durdanovic, I., Samet, H., Graf, H. P.: Pruning filters for efficient convnets. In: International Conference on Learning Representations (2017)
18. Li, H. T., Lin, S. C., Chen, C. Y., Chiang, C. K.: Layer-level knowledge distillation for deep neural network learning. Applied Sciences 9(10), 1966 (2019)
19. Liu, N., Ma, X., Xu, Z., Wang, Y., Tang, J., Ye, J.: Autoslim: An automatic dnn structured pruning framework for ultra-high compression rates. arXiv preprint arXiv:1907.03141 (2019)
20. Liu, Z., Li, J., Shen, Z., Huang, G., Yan, S., Zhang, C.: Learning efficient convolu-tional networks through network slimming. In: Proceedings of the IEEE International Conference on Computer Vision (ICCV). pp. 2736-2744 (2017)
21. Liu, Z., Sun, M., Zhou, T., Huang, G., Darrell, T.: Rethinking the value of network pruning. In: International Conference on Learning Representations (2018)
22. Luo, J. H., Wu, J., Lin, W.: Thinet: A filter level pruning method for deep neural network compression. In: Proceedings of the IEEE International Conference on Computer Vision (ICCV). pp. 5058-5066 (2017)
23. Ma, X., Guo, F. M., Niu, W., Lin, X., Tang, J., Ma, K., Ren, B., Wang, Y.: Pconv: The missing but desirable sparsity in dnn weight pruning for real-time execution on mobile devices. arXiv preprint arXiv:1909.05073 (2019)
24. Min, C., Wang, A., Chen, Y., Xu, W., Chen, X.: 2pfpce: Two-phase filter pruning based on conditional entropy. arXiv preprint arXiv:1809.02220 (2018)
25. Nayak, G. K., Mopuri, K. R., Shaj, V., Babu, R. V., Chakraborty, A.: Zero-shot knowledge distillation in deep networks. In: Proceedings of the International Con-ference on International Conference on Machine Learning (ICML). pp. 4743-4751 (2019)
26. Ren, A., Zhang, T., Ye, S., Li, J., Xu, W., Qian, X., Lin, X., Wang, Y.: Admm-nn: An algorithm-hardware co-design framework of dnns using alternating direction methods of multipliers. In: Proceedings of the Twenty-Fourth International Conference on Architectural Support for Programming Languages and Operating Systems (ASPLOS). pp. 925-938 (2019)
27. Simonyan, K., Zisserman, A.: Very deep convolutional networks for large-scale image recognition. arXiv:1409.1556 (2014)
28. Tai, C., Xiao, T., Zhang, Y., Wang, X., Weinan, E.: Convolutional neural networks with low-rank regularization. In: Proceedings of International Conference on Learning Representations (ICLR) (2016)
29. Wang, J., Bao, W., Sun, L., Zhu, X., Cao, B., Philip, S. Y.: Private model compression via knowledge distillation. In: Proceedings of the AAAI Conference on Artificial Intelligence. vol. 33, pp. 1190-1197 (2019)
30. Wen, W., Wu, C., Wang, Y., Chen, Y., Li, H.: Learning structured sparsity in deep neural networks. In: Advances in Neural Information Processing Systems (NeurIPS). pp. 2074-2082 (2016)
31. Yang, M., Faraj, M., Hussein, A., Gaudet, V.: Efficient hardware realization of convolutional neural networks using intra-kernel regular pruning. In: 2018 IEEE 48th International Symposium on Multiple-Valued Logic (ISMVL). pp. 180-185. IEEE (2018)
32. Yu, X., Liu, T., Wang, X., Tao, D.: On compressing deep models by low rank and sparse decomposition. In: Proceedings of the IEEE Conference on Computer Vision and Pattern Recognition (CVPR). pp. 7370-7379 (2017)
33. Zhai, S., Cheng, Y., Zhang, Z. M., Lu, W.: Doubly convolutional neural networks. In: Advances in Neural Information Processing Systems (NeurIPS). pp. 1082-1090 (2016)
34. Zhang, T., Ye, S., Zhang, K., Tang, J., Wen, W., Fardad, M., Wang, Y.: A systematic dnn weight pruning framework using alternating direction method of multipliers. In: Proceedings of the European Conference on Computer Vision (ECCV). pp. 184-199 (2018)
35. Zhang, T., Zhang, K., Ye, S., Li, J., Tang, J., Wen, W., Lin, X., Fardad, M., Wang, Y.: Adam-admm: A unified, systematic framework of structured weight pruning for dnns. arXiv:1807.11091 (2018)
36. Zhao, C., Ni, B., Zhang, J., Zhao, Q., Zhang, W., Tian, Q.: Variational convolutional neural network pruning. In: Proceedings of the IEEE Conference on Computer Vision and Pattern Recognition (CVPR). pp. 2780-2789 (2019)
37. Zhu, X., Zhou, W., Li, H.: Improving deep neural network sparsity through decorrelation regularization. In: Proceedings of International Joint Conferences on Artificial Intelligence (IJCAI). pp. 3264-3270 (2018).
38. Zhuang, Z., Tan, M., Zhuang, B., Liu, J., Guo, Y., Wu, Q., Huang, J., Zhu, J.: Discrimination-aware channel pruning for deep neural networks. In: Advances in Neural Information Processing Systems (NeurIPS). pp. 875-886 (2018)

1. A method of performing weight pruning on a Deep Neural Network (DNN) model while maintaining privacy of a training dataset controlled by another party, comprising the steps of:
(a) receiving a pre-trained DNN model;
(b) performing a weight pruning process on the pre-trained DNN model using randomly generated synthetic data instead of the training dataset to generate a pruned DNN model and a mask function; and
(c) providing the mask function and the pruned DNN model said another party such that said another party can retrain the pruned DNN model with the training data set using the mask function.

2. The method of claim 1, wherein the pre-trained DNN model is received in step (a) from said another party.

3. The method of claim 1, wherein step (b) uses an alternating direction method of multipliers (ADMM) framework to generate the pruned DNN model.

4. The method of claim 1, wherein step (b) comprises initializing the pruned DNN model in the same way as the pre-trained DNN model, and then discovering the pruned DNN model architecture through the weight pruning process.

5. The method of claim 1, wherein step (b) comprises generating a batch of synthetic data points at the beginning of each iteration of the weight pruning process and using the batch of synthetic data points as training data to prune redundant weights, and wherein pruning is performed layer-by-layer for the whole DNN model.

6. The method of claim 1, wherein the mask function simplifies retraining of said pruned DNN model by said another party.

7. The method of claim 1, wherein the weight pruning process comprises irregular pruning, filter pruning, column pruning, or pattern-based pruning.

8. The method of claim 1, wherein said method is performed by a system designer, and wherein said another party is a client of the system designer.

9. A computer system, comprising:
at least one processor;
memory associated with the at least one processor; and
a program supported in the memory for performing weight pruning on a Deep Neural Network (DNN) model while maintaining privacy of a training dataset controlled by another party, the program containing a plurality of instructions which, when executed by the at least one processor, cause the at least one processor to:
(a) receive a pre-trained DNN model;
(b) perform a weight pruning process on the pre-trained DNN model using randomly generated synthetic data instead of the training dataset to generate a pruned DNN model and a mask function; and
(c) provide the mask function and the pruned DNN model said another party such that said another party can retrain the pruned DNN model with the training data set using the mask function.

10. The computer system of claim 9, wherein the pre-trained DNN model is received in (a) from said another party.

11. The computer system of claim 9, wherein (b) comprises using an alternating direction method of multipliers (ADMM) framework to generate the pruned DNN model.

12. The computer system of claim 9, wherein (b) comprises initializing the pruned DNN model in the same way as the pre-trained DNN model, and then discovering the pruned DNN model architecture through the weight pruning process.

13. The computer system of claim 9, wherein (b) comprises generating a batch of synthetic data points at the beginning of each iteration of the weight pruning process and using the batch of synthetic data points as training data to prune redundant weights, and wherein pruning is performed layer-by-layer for the whole DNN model.

14. The computer system of claim 9, wherein the mask function simplifies retraining of said pruned DNN model by said another party.

15. The computer system of claim 9, wherein the weight pruning process comprises irregular pruning, filter pruning, column pruning, or pattern-based pruning.

16. The computer system of claim 9, wherein said computer system is operated by a system designer, and wherein said another party is a client of the system designer.

17. A computer program product for performing weight pruning on a Deep Neural Network (DNN) model while maintaining privacy of a training dataset controlled by another party, said computer program product residing on a non-transitory computer readable medium having a plurality of instructions stored thereon which, when executed by a computer processor, cause that computer processor to: (a) receive a pre-trained DNN model; (b) perform a weight pruning process on the pre-trained DNN model using randomly generated synthetic data instead of the training dataset to generate a pruned DNN model and a mask function; and (c) provide the mask function and the pruned DNN model said another party such that said another party can retrain the pruned DNN model with the training data set using the mask function.

18. The computer program product of claim 17, wherein (b) comprises using an alternating direction method of multipliers (ADMM) framework to generate the pruned DNN model.

19. The computer program product of claim 17, wherein (b) comprises initializing the pruned DNN model in the same way as the pre-trained DNN model, and then discovering the pruned DNN model architecture through the weight pruning process.

20. The computer program product of claim 17, wherein (b) comprises generating a batch of synthetic data points at the beginning of each iteration of the weight pruning process and using the batch of synthetic data points as training data to prune redundant weights, and wherein pruning is performed layer-by-layer for the whole DNN model.
